(19) United States
(12) Patent Application Publication
(10) Pub. No.: US 2011/0153450 A1
(43) Pub. Date: Jun. 23, 2011

(54) Online members shopping club sales system and scaled bidding process

(76) Inventor: Scott Melvin McBride, North Bay (CA)

(21) Appl. No.: 12/928,720

(22) Filed: Dec. 20, 2010

(30) Foreign Application Priority Data
Dec. 21, 2009 (CA) 2,688,884

(51) Int. Cl. G06Q 30/00

(52) U.S. Cl. 705/26.3

(57) ABSTRACT

The present invention relates to and describes a method and system for Internet shoppers to purchase products at discounted prices using a members only scaled bidding process within an online shopping club. Internet shoppers would become members of a shopping club described in the present invention paying for the membership right and being granted with their membership a number of bids to be used within the shopping club before their membership expires. The shopping club would than use the membership fee to purchase items to be later bid upon by the members using a sliding scaled bidding process described in detail herein. By allowing members to now bid on items that the club has purchased, items are in essence already paid for by the members and not the shopping club, so members may bid ridiculously low dollar amounts in order to be the winning bid and win the right to purchase an item with no fear of bidding to high for the member is not obligated to purchase the item after they are the winning bid. Members with losing bids may still be afforded the option of purchasing the item at the winning bid amount if certain conditions are met.

### BACKGROUND OF THE INVENTION

The present invention describes a system for consumers to make purchases online at vastly discounted prices and offer these discounted prices to a membership only service using a scaled bidding approach that combines features of many auctions and bidding processes.

One thing that never seems to change is people are always looking for a bargain when they make a purchase, a way to save money when shopping. It doesn't matter if it is a small purchase or one life changing, why pay more than you have to if you can buy the same thing, or same quality, for a cheaper price.

Consumers have many options afforded to them now-a-days including many local retailers to their location which often compete by lower the prices of certain items. One of the very best is a well know store called Walmart. Walmart sells thousands of items and advertise that their price won't be beat. Walmart as a corporation has thousands or stores and thus buying power to buy products cheaper than much of their competition.

If not buying locally consumers now use the Internet to make purchases where the products they buy are delivered right to their doors. Many companies have online web sites that consumers access to price shop and make purchases. Many of these are famous web sites like Buy.com and Overstock.com that attract millions of consumers.

Also known in the art are online auction sites such as Ebay.com where people may sell their own products in an auction style type sale. These sites have become vary popular not only as a place to get a great deal, but also a place to sell products and make profits for businesses and individuals.

There are also many different types of auctions in the world and many of these are found online. Some such auctions include the English auction where people bid against one another, driving the price of the item up until no more bids are offered and the item sells to the highest bidder.

Another type of auction is known as the Dutch auction where the bidding starts high and ends when the first person is willing to pay the auctioneer's price. This type of auction became popular in the Netherlands for companies buy flowers and other perishable goods.

Still another type of common auction is a Sealed auction also known as a First-Price, Sealed Bid Auction (FPSB) where bidders bids are sealed and when revealed the highest bidder wins the item. In this type of auction bidders have no idea what other bidders are bidding and often bidders don't know how many people are bidding or sometimes even who they are. A variation of this type of auction is called the Vickrey where the highest bidder wins the auction but only pays the second highest bid rather than their own.

Yet still another form of auction may have a Reserve attached to the item being auctioned so that the seller does not have to sell the item if the final bid does not satisfy their reserve price. More attractive to consumers are No-Reserve auctions where the item will be sold regardless of price. Consumers like this type of auction as great bargains may be had when an item sells at a very low price, even sometimes at a loss to the seller.

Another option consumers have besides buying locally in retailers, online at web sites, or in auctions in person or online, but is through being involved in a Shopping Club. A very popular shopping club is Costco. Costco charges members a membership for the right to be able to make purchases and save on discounted items.

Online there are several shopping clubs that use their buying power to purchase products that are than passed along to their members, be it private members by invitation only or open to anyone from the public to join and be a member.

Notwithstanding the usefulness of the above-described methods, it is a goal of the present invention to provide a system combining many of the best features of all these kinds of consumer shopping habits including many of the best aspects of different kinds of auctions and the benefits or shopping clubs to allow an improved system where members may find huge savings and discounts of products and services.

### SUMMARY OF THE PRESENT INVENTION

The present invention refers to a system and method for allowing a members only Internet based shopping club, the ability to buy at discounted bargain prices using a Sliding Scaled Bidding process where the shopping club has no costs and recoups the costs of all items sold, for the membership as a whole has pre-paid for all items the membership bids on.

It is one objective of the present invention to provide an Internet web site that members may use to shop for consumer related products and services (interchangeably called Items throughout) at discounted prices over competitors.

Further it is an objective of the present invention to charge members for participation in the web site related to that of the present invention if they wish the opportunity to receive better deals that non members if non members are allowed to participate.

Still a further object of the present invention is to use members membership fees to purchase items the shopping club will than provide for sale back to the members at a great savings to the members.

In another embodiment of the present invention a new style of auction or bidding process is introduced called “Sliding Scaled Bidding”, that combines features of a Dutch Auction, Reserve Auction, No-Reserve Auction, and Sealed First Price Auction.

Another object of the present invention allows for a limited number of members to participate in each bidding process using the Sliding Scale Bidding method describe.

Still another objective of the present invention is to include combining both a No Reserved and a Reserved amount for items sold so members may buy items that sell regularly for thousands of dollars for just hundreds or dollars and still allows the shopping club the ability to place Reserved amounts on secondary products and services that may be sold to the limited number of members participating in the Sliding Scale Bidding methods describe.

Still yet a further objective of the present invention affords one member, per item sold, the opportunity to purchase a product or service at vastly discounted prices but also using the Sliding Scale Bidding process of the present invention and the possible Reserve price of the secondary items, many members may be offered the same discounted prices for the same item at their choosing so now members losing in the bidding process can still be offered an opportunity to purchase products at the same price as the winning of the bidding process.

In still a further objective of the present invention members are afforded the opportunity to participate in a certain amount of bidding processes before their membership expires, whereas each bid would be for a different item sold and membership may be renewed by a member when their membership expires.

Still another objective of the present invention allows the member with the winning bid the option to purchase the item they won with their bid on the item or pass and allow the next highest bidder the right to purchase the product and so forth until a bidder purchases the item won during the bidding process.

Still a further object of the present invention allows members to view products and services they may bid on including the number of other members who are also bidding, retail prices, past bid amounts for this same item as well as members bidding are allowed to enter a low bid and a scaled higher bid they are willing to spend on the item as well as dates and times for withdrawing from the bidding process of an item as well as numerous other features involved in the process.

Still a further objective of the present invention allows for the shopping club to contact members advising them of results of the bidding processes they entered or others they did not enter and whereas winners are advised instructions for claiming the item the won the right to purchase as well as time constraints for making the purchase and so forth.

Still yet a further objective of the present invention allows the shopping club to survey their membership to predetermine what items to offer to the membership as well as approximate amounts members would be willing to pay for these items to the shopping club can make the best buying decisions with their buying power and maximize the savings for its members and at the same time the profits for the shopping club.

### BRIEF DESCRIPTION OF THE DRAWINGS

FIG. 1 is a block diagram of the members only shopping club of present invention

FIG. 2 is a block diagram of the bidding process and scaled bidding process of one embodiment of the present invention.

### DETAILED DESCRIPTION OF THE PREFERRED EMBODIMENT

The present invention relates to a method and system for Internet shoppers to purchase products at discounted prices. In one embodiment of the present invention Internet shoppers would become members of a shopping club described in the present invention. In still a further embodiment of the present invention members who join the shopping club would pay a membership fee for joining and be awarded with a number of bids that may be used when purchasing products from the shopping club. The shopping club would than use the membership fee to purchase items to be later bid upon by the members using a sliding scaled bidding process described in detail herein. By allowing members to now bid on items that the club has purchased, items are in essence already paid for by the members and not the shopping club, so members may bid ridiculously low dollar amounts in order to be the winning bid and win the right to purchase an item with no fear of bidding to high for the member is not obligated to purchase the item after they are the winning bid. In yet another embodiment of the present invention members with losing bids may still be afforded the option of purchasing the item at the winning bid amount if certain conditions described herein are met.

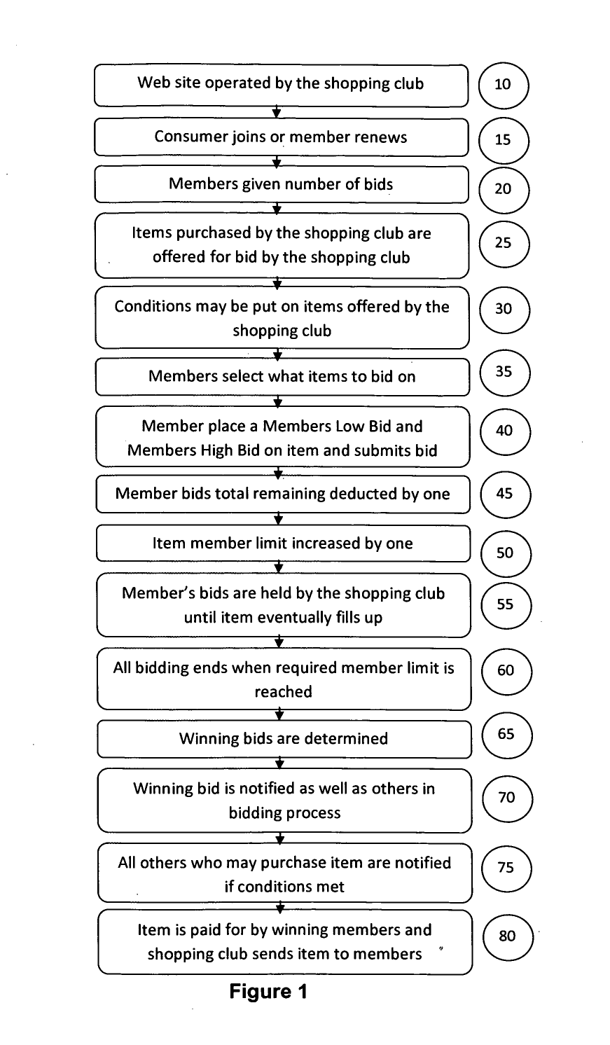

In FIG. 1 the process involved in creating that of the present invention is shown. A web site 10 accessed over the Internet is offered in the present invention. In the preferred embodiment this web site would be accessed over the Internet and is for members only 15, although it is possible to be used by non members as so they can experience the web site and the features and advantages offered by the shopping club 10 that operates the web site. Users of the web site may be afford a variety of options and it is understood members and non members may be afforded different options within the web site.

For members who 15 join the web site 10 in the present invention they will likely be charged a fee for membership. This fee is paid to the operator 10 of the web site, in this case the owners of the shopping club company. In turn for their membership each member receives 20 a package that may include among other things a number of Bids. As an example, a member could join 15 the shopping club 10 and be a member for $50. This member 15 may now receive with their paid membership a number of bids 20 to be used for bidding on items offered for bid 25 by the shopping club. As an example we will say that for the $50 membership 15 a member will get 200 Bids 20 that may be used when participating in the web site. Members will use their Bids at their own description 35 and once their Bids are used up this members membership may expire and of course this expired membership may be renewed 15 at even greater offerings to the member to entice them to renew their membership.

The shopping club would now use membership fees to make purchases 25 of different products and services (we'll refer to products and services interchangeable as Items throughout the present invention). These Items 25 would be purchased in bulk at discounted prices directly from the manufacturers and the shopping club would use its buying power to get great discounts for these items 25 purchased. The shopping club would survey there members for what items the membership wants the shopping club to purchase and as such the shopping club now has a good idea as to the demand of their members 15 and the shopping club would make purchases in accordance with the demand of their membership as a method to make responsible purchases 25 to maximize the savings for its members as well as the profits for the shopping club.

As an example the membership through surveys has told the shopping club there is a demand for “XYZ TVs” (TVs). These TV's may be a very hot item at retailers and the members are no different as they are looking to buy these TVs. The shopping club would also survey the membership for what price these members are willing to pay when bidding on and buying one of these TVs at the shopping club. As an example 10,000 members have said they'd pay on average $750 for one of these TVs if offered through the shopping club. Using this information the shopping club would (may try to) strike a deal with the manufacturer of these TVs for a price less than $750 which the shopping club knows 10,000 members have expressed interest in purchasing at that price. The shopping club would work the best possible deal 25 with the manufacturer for a certain number of these TVs, say 1,000. Lets assume the manufacturer gives the shopping club a special deal of $400 per TV for the shopping club is buying 1,000 TVs. These same TV's may be retailing in stores for about $1,200 to $1,500. The shopping club would 25 buy these 1,000 TVs at $400 each or $400,000 worth of TVs.

The shopping club would now offer one of these TVs up for Bid 25 with all the information describing the TV 30, including retail price, average price sold by the shopping club, description, shipping information, number of members allowed to bid on this item and pictures of the TV. Members of the shopping club could now view these items 35, in this case the TV and decide if they wish to place a bid 35 on the TV. In this example the shopping club would specify how many Bids 30 will be excepted on this TV, say for an example 1600 bids. Each member can only bid once per item sold 30 (so only one bid of the 1,600 bids per member, in this example), but members could get back in on the same product in a different bidding round (that is to say a member could place another bid on this same item if the item is placed up again in the future which is considered a different bidding round). Members are shown how many bids are being accepted 30 on the item and the winning bid 65 is not known or made known until the full 1,600 bids 55 have been accepted by the shopping club. In the preferred embodiment of the present invention members do not know what other members have place or made a bid 35 on this item, however, it is possible this information may be afforded to the members.

If a member bids 35 on this item, their total allowed number of bids 45 would be deducted by 1 or possibly more depending on the conditions 30 made known to all members for an item and before any bids 35 are accepted. In our example they were given two hundred Bids 20 for their membership 15 and using one here for this TV would cause them to have only one hundred and ninety-nine (199) bids remaining in their membership 15. Each member who bids 35 will be asked to select the bid they would like to purchase the product for 40 as well as a secondary bid, that is a higher amount 40, the most they'd be willing to pay for the item 25. We will referred to these as a “Members Low Bid” (MLB) 40 and “Members High Bid” (MHB) 40. The MLB 40 is the amount the member is hoping to pay for the item. The MLB 40 is encouraged by the shopping club to be a low dollar amount as so the member gets a huge savings if they win the right to buy the item 70. The MHB 40 is the highest amount the member is willing to pay if their MLB 40 is not the winning bid 65. As an example let's say this member bid $235 as their MLB 40 as the amount they are hoping to win the bid at but decided as a MHB 40, they'd be willing to bid up to $260.

MLB=$235

MHB=$260

In one embodiment of the present invention the item being bid for 35 is already purchased 25 by the shopping club and therefore members are encouraged to bid extremely low with both their MLB 40 and MHB 40 bid amounts, as the shopping club wants their members to get the best deals possible as the better the deals of the membership 15, the better and easier to attract new members 15 to the shopping club to take part in these great deals. If the bid in this example was for only one TV 25 and all 1,600 bids 30 have been received 60 the sliding scaled bidding process would start 65. The sliding scaled bidding process is an internal process by the shopping club to determine the winning bid 65 on an item. Each of the 1,600 MLB bids 40 and MHB bids 40 would be evaluated 65 and the highest such MLB bid 40 or MHB bid 40 of all 1,600 bids 30 for this one TV 25 would be the winning bid 65 and that person would be allowed to purchase the TV 70. However, if a no MHB 40 is higher than the highest MLB 40, the member with that highest MLB 40 would win the right to purchase the item 65 for their MLB amount 40 and their particular MHB bid 40 would be ignored. As an example, If the highest MLB bid 40 and MHB bid 40 of the 1,600 bids 30 was the MLB 40 above of $235, that member would be allowed to purchase the item 70, in this case the TV for $235 plus possible shipping on the product if a fee for shipping was required 30 (this amount likely known to all members before they bid). Buying this TV 70 for only $235 is below what a retailer could actually purchase the TV at wholesale costs for the manufacture doesn't even sell the TV that cheaply, as the TV wholesales for greater than $400, which is the price the shopping club 25 paid because they bought 1,000 units, even though the shopping club sold the TV for only $235, which was the winning bid 65.

Staying with the same example above where another member (we'll call this member Member #2) had instead had a MLB 40 of $230 and a MHB 40 of $270 and the member that won above (we'll call them Member #1) had bid the same MLB 40 of $235 and a MHB 40 of $260 there would have been a different outcome of this scaled bidding process and in this example Member #2 would have won the bidding process 65 and the right to buy the TV for $270.

### Member #1

MLB=$235

MHB=$260

### Member #2

MLB=$230

MHB=$270

The highest MLB 40 of all the bids 60 was $235 by Member #1, however, there was higher MHB bids 40, in this example, Member #2 at $270. In the preferred embodiment of the present invention member #2 would not have to pay $270, but just some determined amount over $260, the next closest bid. In the preferred embodiment of the present invention it is likely that winning bid 65 Member #₂ may only have to pay $261 for the right to purchase the TV 70, which is less than they were willing to spend 40, but not as much as they had to spend 40 to win the bidding process 65.

It is understood that in the above example we only isolated just two members bids for this item's bidding round and there were 1,600 members in total whom made bids. We are only showing the wining bid or top member's bids for comparison for the other 1,598 bids, in this one example, were lower MLB bids 40 and lower MHB bids 40.

After each bidding process for an item has concluded and winning bids are determined winners are notified 70 as well as others who did not win. Also if others were allowed to purchase the item 75 because either the reserve was met 30 or because the member with the winning bid elected not to purchase the item, they will be notified. After an item is paid for 80, items are shipping or delivered to the member who made the purchase.

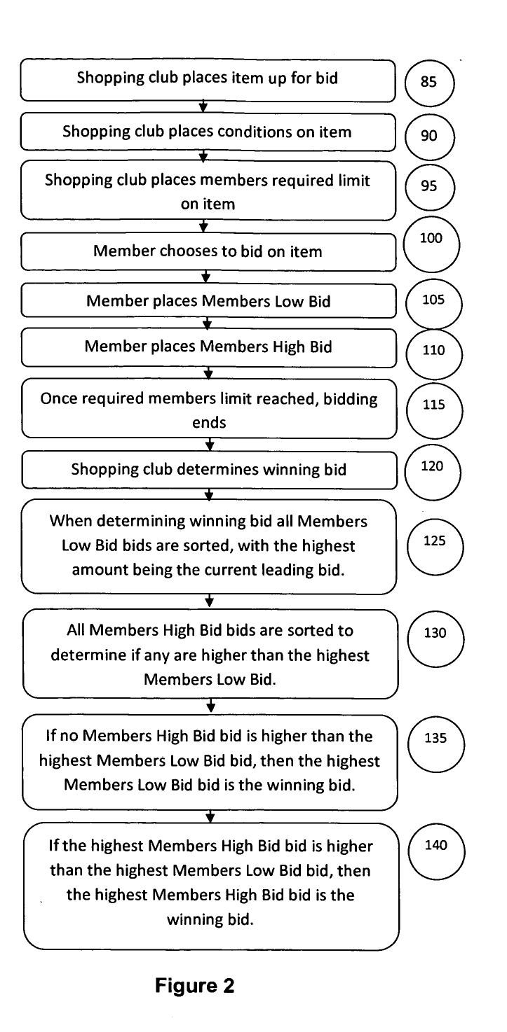

FIG. 2 shows the sliding scaled bidding process. In still another embodiment of the present invention a sliding scaled bidding process occurs for this item 85 and the shopping club may place a Reserved Bid 90 on additional TVs after the first one in the bidding process and the club may also state how many TVs 90 are possibly up for bid during the bidding process. The shopping club may also attach Scale Limits 90 between the amounts a member may place between their MLB bid and their MHB bid as well as Winning Limits 90 as to the amount a member must be within the winning bid to, qualify for the purchase of the additional TVs that may or may be offered to the members after the bidding process depending on all these requirements 90.

Breaking this down further the shopping club may potentially offer more than one of the TVs 85 during a bidding process. The shopping club would advertise the rules and requirements 90 of the members for this particular bidding process. The shopping club might offer one TV with No Reserve bid 90 and allow the limit of the 1,600 members to bid. There is No Reserve bid of course for the TV is paid for through the mathematics of allowing 1,600 members to bid on the TV and using up one bid each of their two hundred membership bids. The shopping club does not care what this first TV sells for, be it $10. However, many TVs might be advertised 90 for this one bidding process and the shopping club would make this known to members 90 ahead of allowing the first of the 1,600 members 95 to place their bid 100. One such thing the shopping club will make known 90 is the potential number of items, in this case the TVs that may be offered during this bidding process. Since the shopping club has 1,000 total TVs and one is being offered they may elect to also potentially offer 999 more TVs this bidding process. The members would now know there may be many additional TVs potentially 90 allowed for purchase during this bidding process if certain conditions 90 are met. One of the conditions 90 the shopping club might put on this bidding process for the additional 999 TVs is a secret Reserve Bid 90 confidentially only known by the shopping club operators and not known by the membership.

Additionally the shopping club may place other requirements such as Scale Limits 90 between the amounts a member may place between their MLB bid 105 and their MHB bid 110. The reason for this is so every member does not bid a MLB 105 of $1 and a MHB 110 of what they are hoping to win the bid 120 and pay for the TV, say a MHB of $600. The shopping club may place Scale Limits 90 of some stated amount for this bidding process of the difference a member may place between the MLB bid 105 and MHB bid 110, say as an example $50. A member bidding in this process 100 who bid $1 with the MLB bid 105, would than only be able to bid a maximum MHB bid 110 of $51 under this set of requirements 90 placed by the shopping club. Of course these Scaled Limits 90 could vary from same items sold 85 to different items and, as an example, a different bidding process for this same TV 85 might have a $100 Scale Limit 90 whereas a bidding process for a different item altogether, say a Women's Curling Iron for their hair 85, might have a Scale Limit 90 of $5.00 or any such amount.

Still additionally the shopping club could place Winning Limits 90 as to the amount a member must be within the winning bid to qualify for the purchase of the additional TVs that may or may be offered to the members after the bidding process depending on all these requirements 90. In this example, if the shopping club was offering 999 more TVs 90 during this bidding process the shopping club may require a member's MLB bid 105 or MHB bid 110 to be within a certain amount of the winning bid, known as a Winning Limit 90, to qualify to purchase one of the additional TVs if all other of the requirements 90 have been met. So if the Winning Limit 90 placed by the shopping club was $100, any member's MLB bid 105 or their MHB bid 110 must be within $100 in this case to qualify for the right to purchase one of these additional 999 TVs as long as the reserve price 90 of the bidding process has been met. Under the preferred embodiment of the present invention a Top Down process would occur whereas if more than 999 people qualified to also purchase a TV, a member who had a higher top bid would be offered the chance first before a member who had a lower top bid amount, but if the member with a higher bid passes on their right to make a purchase, than the next lower member in line would than be offered the right to make the purchase. Although in theory, every member in the bidding process could be offered a chance to purchase the item if the reserve 90 is met, if the shopping club had that many of the item being offered 90, it is in the interest of the shopping club to have Winning Limits 90 to entice members to make appropriate bids and not just low bids with no intention of winning the main bid but just wanting to purchase the additional TVs if the reserve is met, thus hoping for a very low winning bid.

Staying with this same example, the shopping club might tell its members, one TV is up for bid with 999 more 90 being sold if the reserve price 90 is met. The shopping club could place a reserve price 90 not known to the members and in this example, say $500 (Reserve) for any additional TVs sold for this bidding process. It is understood that the same item 85 could have a different Reserve 90 in a different bidding process, either higher or lower and all depending on the desires of the shopping club. The shopping club would go through a similar process as stated previously allowing 1,600 members 95 to place an initial low bid (MLB) 105, the price they are hoping to purchase the TV at, but also a second higher bid (MHB) 110, a higher bid, if they desire, than the low bid 105 that they are also willing to pay for the TV if their MLB bid 105 is not the lowest bid at the end of the bidding. Also the shopping club would make it known if there are any Scale Limits 90, the maximum difference between a MLB bid 105 and a MHB bid 110 as well as if there is a Winning Limit 90 attached to the winning bid, say of within $50, and that a member must come within that amount of the winning bid, if the reserve 90 is met, to have the opportunity to purchase one of the 999 additional TVs off the reserve.

If as in the previous example, the TV sells for $235, than only that one member gets the TV and no others are offer a TV from the additional TVs for the reserve 90 of $500 was not met. However if the winning bid ended up to be $650, that the member who ended with the winning bid is afforded the right to purchase the TV for that amount but also starting with the member with the next highest bid, they are allowed to purchase the TV for the winning bid of $650, buying one of the 999 on reserve because the reserve price was met. Each member would be afforded this option if they had a losing bid that was within the required $50 (Winning Limit) of the winning bid as posted 90 by the shopping club before the bidding officially started. If 999 bids were all within $50 of the winning bid, each member could buy the TV for that price using the Top Down approach if more than 999 members qualified, offering the TV for sale to the top bidders first and on down. Members choosing not to buy a TV at this price are under no obligation to do so and can just pass. Members have the opportunity to go in future bidding processes for this same product if further like items are still offered by the shopping club 85. The shopping club would continue to offer this TV while their supplies last, over and over to a limited number of members at a time 95 in different bidding processes and with a possible number on reserve 90 until all the 1,000 TVs were sold. This could happen over many different bidding processes or the first one depending on many factors such as the winning bid price 120, the reserve being met 90, the number of TVs in this bidding process 90, the Winning Limit set 90, and how many members entitled to make the purchase of the TV carry through and decide to buy the TV at the amount of the winning bid. If after all 1,000 TVs were sold by the shopping club, the average TV sold for $600, the shopping club would have made $600,000, of which $200,000 is profit and the shopping club would now have $400,000 to purchase more items for future sales to the members.

The sliding scale bidding process has many features. By simply taking the highest of the bids, a bidder who was very close to the winning bid, say within $1, would lose out even though they were very close and in the ball park to the winning bid. Using the sliding scale a member is given an additional opportunity to increase the amount of their lowest bid to a higher and possibly a more competitive bid. By allowing thousands of people to bid on the bigger items the shopping club will make higher profits as items would not sell quite as cheaply as if fewer people bid on an item, although, the shopping club promotes and does hope for products being sold for high saving to the members, for this ultimately attracts and retains more members. By allowing the sliding scale bidding a member can now firstly determine what they'd like to purchase the product for, however, if they miss and someone else bids higher, the member now has the opportunity to select just how high they would be willing to bid on this product (staying within any preset Scale Limits). Each process has sliding Scale Limits as so a member could not bid one dollar as a low bid (MLB) and $1000 for a high bid (MHB) on this TV as they are not seriously hoping to buy the TV for only one dollar. If this process had a $50 Scale Limit, they'd only be able to increase their high bid (MHB) by $50, so from $1 to $51. This makes the members take the bidding process serious as they are losing one of their bids for participating and now will be out one bid. Also the sliding scale bidding process allows bidders who were close to the top bid, the right to counter and increase their bid for the right ton win the bidding process and also be allowed to possibly purchase the product if additional items are offered and the reserve price was met, all bidders within the Winning Limit set by the shopping club, of the winning bid, in this case also $50, would be allowed the right to buy the item for that same winning bid amount using the Top Down method in order of high bids on down if items were limited in quantity. This sliding scale process allows the shopping club to be very competitive but also get the maximum dollar for each item sold as well as great savings for it's members.

The shopping club cannot take a loss on any item it sells and the more members joining will create the more buying power as membership money is circulated back into buying more and more products for less and less as the shopping club grows. Items that sell really inexpensively, say if this $400 TV, that is the shopping clubs cost, sells to a member for $10, the shopping club did not lose anything as the TV was paid for already and even though one member really received a TV that retails for $1200 to $1500 for only $10, the shopping club did not lose any buying power or money, but actually profited the $10. Even though membership fee money does not disappear from the shopping clubs buying power, membership does disappear as members use up their bids, so they will have to eventually buy more bids. The longer the shopping club goes and the more members it retains the higher its buying power grows providing even further discounts to its members.

In still another embodiment of the present invention instead of using the Top down approach for offering the additional items for sale when the Reserve price has been met, all members who qualify as having the right to purchase an additional item may be contacted, say by email as an example, and given instructions by the shopping club. In one embodiment these instructions may include a time limit, for instance, a seven day period in which the member would have to make a purchase before their right on this item expires. The shopping club may also notify their members that there are a limited number remaining and the first members to make the purchases will be the members who are allowed the right to purchase the item as so not necessary using a Top Down approach for the additional items to be sold when the Reserve has been met.

In another embodiment of the present invention members have their own account where a member can log in and see information about their usage in the shopping club. This information may include the remaining number of bids in their membership as well as special promotions and offerings the shopping club has for them, such as renewal bonus and offers. Also included for each member will be previous bid information and statistics on how their bids have compared with winning bids so each member can have as much information as possible when they make a bid on a item. For instance, if a member was to bid on a TV and has previously bid on two others, exactly the same TVs, a member could be shown their bids as compared with the winners bids and how close they came in actual dollars or percentages of the winning bids. Giving each member statistical information they can determine that there is a savings to the winners of the items sold and that if they alter their own bids accordingly they may have a better opportunity of winning the bidding process. Using this same logic a member may determine they do not want to pay the amount the TVs are selling for, thus saving their own bids for other items the shopping club offers.

In one embodiment of the present invention members who place bids do not have to be present online when the winning bid is determined and may elect to be contacted in a variety of different ways. One such way a member might be contacted is through an email or through their account within the web site of the shopping club. Members will have options afforded to them such as them being notified in advance upon the closing of the item. Members will know when the limited amount of members required to start the bidding process has been filled and if there is a delay at this point in when the bidding process will be determined, members involved may be given a time and date whereas they may login to the shopping club and watch the results determined live. This may add excitement for some members who want to witness the results. This can be achieved as easy as starting a price amount and watching it drop over a time period, say every second until the highest MLB bid is reached and than start to rise until the highest MHB bid is reached if any MHB bid is higher than the highest MLB bid reached. It is possible all items are played out this way or just a select view, while others are just determined internally and members are notified with the results.

Using the Sliding Scaled Bidding process and in determining winning bids 120 all members within a bidding process, after the required number of members has been reached 115, will firstly have their MLB bid 105 compared with each other MLB bid 125 and the member with the highest MLB bid 125 will become the currently leading bid. All members will than have their MHB bid 130 sorted to determine if any MHB bid 110 are higher than the current leading bid 125, which is the Highest MLB of all MLB bids. If no members MHB bid 110 is higher than the highest MLB 125, then the leading bid, which is the highest MLB 125 is the winning bid. However, if the highest MHB bid 110 is higher than the currently leading bid, which is the highest MLB bid 125, then the highest MHB bid 110 is the winning bid 140.

We claim:

1. A method for using an Internet web site for selling items online comprising the steps of: (a) A user accessing the web site through the use of a device such as a computer and; (b) A user viewing the web site and items available for purchase by members and; (c) A user paying a fee to become a member of the web site and; (d) Granting members a number of bids usable within the web site and; (e) Allowing members to place bids on items offered for bidding within the web site and; (f) Determining winning bids and; (g) Offering the item bid on to be purchased by the member of the winning bid and; (h) If purchased by the member of the winning bid, accepting payment for item purchased and; (i) If not purchased by the member of the winning bid, allowing the next highest bid and so forth the right to purchase the item for the amount of the winning bid and accepting payment for the item purchased and; (j) Shipping item to the member of the winning bid, or other purchasing member, if payment is received.

2. A method of claim 1, wherein: (a) The Internet web site is a shopping club and the shopping club purchases items for its members to bid upon and; (b) The Internet web site posts information about each item such as; (1) A description of the item; (2) Pictures of the item; (3) Retail prices of the item; (4) Previous winning bid prices of the item; (5) Number of members required to bid on an item before winning bid will be determined; (6) Number of additional items that may also be purchased after the winning bid is determined; (7) Advising members if a reserve amount has been placed by the operators of the Internet web site for any additional items potentially offered for purchase after that of the winning bid; (c) The Internet web site allows users to access the web site through the use of a device such as a computer and; (d) The Internet web site allows a user viewing the web site to view items available for purchase to become members and; (e) The Internet web site allowing a user to pay a fee to become a member of the web site and; (f) The Internet web site granting members a number of bids usable within the web site and; (g) The Internet web site allowing members to place bids on items offered for bidding within the web site and; (g) The Internet web site determining winning bids and; (h) The Internet web site offering the item bid on to be purchased by the member of the winning bid and; (i) The Internet web site, then if purchased by member of the winning bid, accepting payment for item purchased and; (j) The Internet web site, then if not purchased by the member of the winning bid, allowing the next highest bid and so forth the right to purchase the item for the amount of the winning bid and accepting payment for the item purchased and; (k) The Internet web site then shipping item to the member of the winning bid, or other purchasing member, if payment is received.

3. A method of claims 1 and 2, wherein: members who pay a fee to join are granted a plurality of bids and; (a) A member may only bid once per bidding process on an item and; (b) A member who bids on an item has their plurality of bids decreased by one and; (c) When a member uses all of their plurality of bids they may no longer bid on items and; (d) When a member uses all of their plurality of bids they may buy more bids.

4. A method of claims 1 and 2, wherein: members who bid on items are encouraged to bid low dollar amounts to receive as much of a discount as possible but yet bid high enough to be the winning bid whereas; (a) A member makes a low bid that they are willing to pay for an item and; (b) A member if they also choose to do so, also makes a higher bid then the low bid.

5. A method of claims 1 and 2, wherein; a predetermined number of members who may bid for an item is posted and the bidding process does not take place until the predetermined number of members bids has been reached.

6. A method of claims 4 and 5, wherein: after the predetermined number of members have placed bids on an item; (a) all members who bid on the item will have their low bids compared with each other and the member with the highest low bid will then have that bid compared against all members who bid and placed a high bid whereas; (1) If no members high bid is higher than the highest low bid, the member with the highest low bid has the winning bid and is allowed the option of purchasing the item for that bid amount or; (2) If some members highest high bid is higher than the highest low bid then that members highest high bid is the winning bid and is allowed the option of purchasing the item for that bid amount.

7. A method of claim 4, wherein: limits may be placed on the amount a member's high bid may be above that of their low bid.

8. A method of claims 1 and 2, wherein: more than one item may be offered to be purchased by members bidding within the same bidding process if conditions are met.

9. A method of claim 8, wherein: members are made aware a reserve price must be obtained during this bidding process before the additional items that may also be purchased during this bidding process will be offered during this bidding process, however, this reserve price is not known to the members and; (a) If after the winning bid is determined if the winning bid is not equal to or higher than that of the reserve price then none of the additional items will be offered for purchase during this bidding process or; (b) After the winning bid is determined and the winning bid is equal to or higher than that of the reserve price then the additional items may be offered for purchase during this bidding process if other conditions are met.

10. A method of claim 9, wherein: if the reserve price was met all members bidding on this item during this bidding process would be allowed to purchase one of the additional items available for purchase for the amount of the winning bid it (a) The members low bid or the members high bid was within a predetermined amount of the winning bid and; (b) The member acted quick enough within any required time constraints and; (c) If enough quantities of the item are available if limited by the time the member acted upon their purchase.
